(19) United States
(12) Patent Application Publication
(10) Pub. No.: US 2016/0180884 A1
(43) Pub. Date: Jun. 23, 2016

(54) METHOD AND SYSTEM FOR SYNCHRONIZATION OF MULTIPLE CONTENT STREAMS

(71) Applicant: Benjamin Nowak, Atlanta, GA (US)

(72) Inventor: Benjamin Nowak, Atlanta, GA (US)

(21) Appl. No.: 15/056,306

(22) Filed: Feb. 29, 2016

Related U.S. Application Data
(63) Continuation-in-part of application No. 14/883,262, filed on Oct. 14, 2015.
Application No. 14/883,262 is a continuation-in-part of application No. 14/883,303, filed on Oct. 14, 2015.
Application No. 14/883,303 is a continuation-in-part of application No. 15/049,669, filed on Feb. 22, 2016.
(60) Provisional application No. 62/064,464, filed on Oct. 15, 2014.

(51) Int. Cl. G11B 27/031; G11B 33/10; G11B 31/00; H04N 5/247; H04N 5/05

(52) U.S. Cl. CPC G11B 27/031; H04N 5/247; H04N 5/05; G11B 31/006; G11B 33/10

(57) ABSTRACT

Disclosed is a method of and system for synchronizing video content in a multi-angle content capture setup. The method may include generating at least one code image using at least one syncing device. Further, the method may include displaying the at least one code on a display of the syncing device. In some embodiments, the code image may include one or more metadata. Thereafter, the code image may be captured by a first camera device in a first video content stream. Further, the at least one syncing device may display a second code image which may be captured in a second video content stream using a second camera device. Subsequently, the first video content stream and the second video content stream may be synchronized based on metadata obtained from the first and the second code images.

### RELATED APPLICATIONS

The present application is a continuation-in-part to related U.S. patent application Ser. No. 14/883,262, filed on Oct. 14, 2015 the name of the present inventor and entitled “CONTROLLING CAPTURE OF CONTENT USING ONE OR MORE CLIENT ELECTRONIC DEVICES,” claiming priority from provisional patent application No. 62/064,464, filed on Oct. 15, 2014, which is incorporated herein by reference in its entirety.

The present application is a continuation-in-part to related U.S. patent application Ser. No. 14/883,303, filed on Oct. 14, 2015 in the name of the present inventor and entitled “CREATING COMPOSITION OF CONTENT CAPTURED USING PLURALITY OF ELECTRONIC DEVICES,” claiming priority from provisional patent application No. 62/064,464, filed on Oct. 15, 2014, which is incorporated herein by reference in its entirety.

The present application is a continuation-in-part to related U.S. patent application Ser. No. 15/049,669, filed on Feb. 22, 2016 in the name of the present inventor and entitled “PRESENTING CONTENT CAPTURED BY A PLURALITY OF ELECTRONIC DEVICES,” claiming priority from provisional patent application No. 62/064,464, filed on Oct. 15, 2014, which is incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF THE INVENTION

Generally, the disclosure relates to video processing. In particular, the disclosure relates to the methods, apparatus and devices for synchronizing video content captured from multiple video capturing devices.

### BACKGROUND

Digital photography has made the process of capturing content very simple. Cinematographers today generally use multiple video cameras or capturing devices to capture content of a particular event. The capturing devices may be used simultaneously or in succession.

When there is content from multiple capturing devices of an event there is need to synchronize the content originating from the multiple capturing devices in order to present the content in an effective manner to an audience. In order to synchronize the content from multiple capturing devices, a process known as editing may be performed. During editing, the video content from the multiple capturing devices may be viewed and the appropriate sections of the content from the multiple capturing devices may be synchronized to produce a final video.

Today, there are many methods employed to synchronize motion pictures captured across various capturing devices simultaneously. One such method is based on a clapboard in which an operator claps the clapboard within visual and aural reach of all the capturing devices simultaneously recording a scene. Thereafter, a person may manually line up content from various capturing devices and synchronize them to produce a coherent video content. The manual process may be cumbersome and time consuming.

Further, an alternative to the clapboard based method may utilize a software configured to synchronize video tracks based on their audio track content. The use of such software may reduce the time but the process may still be time consuming and confusing to the person performing the editing.

A further solution to synchronizing the content from multiple capturing devices may include using a dedicated time code sync hardware that connects to all the capturing devices. The dedicated time code sync hardware may be expensive and may require highly qualified technician to connect the hardware to all the capturing devices. Therefore, the dedicated time sync hardware may not be cost effective for widespread use.

Therefore, there is a need for improved methods and systems for synchronizing video content from multiple capturing devices in order.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is a syncing device configured to generate a code image for synchronization of a plurality of video content streams captured from multiple angles. Although the term “CODE” is used throughout the present disclosure, it should be understand that the code may comprise an image, a sequence of images, a flash of light, a sequence of flashing light, an object, or any other indicator that may be observed by a content capturing device. The syncing device may include a user interface module configured to receive an indication of a control-input. Further, in some embodiments, the syncing device may include a communication module configured to communicate data between one or more associated syncing devices. The communication may include wireless transmission of the control-input to the one or more syncing devices. Further, the means to generate the code image may be activated in response to the received control-input.

Also disclosed is a method for facilitating the synchronization of a plurality of video content streams captured from multiple angles. The method may include generating at least one code image using at least one syncing device. Further, the method may include displaying the at least one code image on a display of the at least one syncing device. Furthermore, the method may include causing a first captured video content stream to include an image of the at least one syncing device displaying a first code image. The method may further include causing a second captured video content stream to include an image of the syncing device displaying a second code image. Additionally, the method may include synchronizing the first and second captured video content streams based at least in part on the first and the second code images.

Further, in various embodiments, a plurality of syncing devices may be used. The plurality of syncing devices may be synchronized before capturing the code image on the plurality of video content streams. Furthermore, the plurality of syncing devices may be communicatively coupled to each other by a wireless connection such as, but not limited to, Bluetooth, ZigBee and Wi-Fi.

In various embodiments, the code image displayed by the at least one syncing device may be captured in the plurality of video content streams at different times. Further, the code image captured in the plurality of video content streams may be different from each other or identical to each other. Additionally, the code image captured in the plurality of video content streams may convey information to a director while editing.

In various embodiments, the at least one syncing device may display the code image which may be captured in each of the plurality of video content streams. Further, in some embodiments, the at least one syncing device may flash the code image which may be captured in each of the plurality of video content streams at the same time.

Additionally, in some embodiments, the code image generated by the at least one syncing device may be captured on the plurality of video content streams at a plurality of time instants. For example, the code images may be flashed by the syncing device at different time instants.

In various embodiments, the at least one syncing device may be placed in front of a camera capturing a video content stream. Further, the at least one syncing device may be introduced in the frame of the video content stream at any instance of time, either before or after the commencement of the capture of the video content.

In various embodiments, the code image may include at least one of a series of flashes and a complex visual. For example, the code image may be a series of light pulses/flashes. In another example, the code image may be a 2 dimensional barcode such as a QR code. In further embodiments, the at least one syncing device may be configured to generate the code image based on information to be conveyed.

In various embodiments, the code image may include identification of at least one of a camera and a scene. In some cases, the code image may include timing information which may be used to synchronize the plurality of video content streams from multiple cameras.

In various embodiments, the at least one syncing device may provide metadata containing time information. For example, the at least one syncing device may provide the time of appearance of the code image in a particular video content stream of the plurality of video content streams. In an exemplary embodiment, the metadata may be encoded in the code image. Further, in some embodiments, the metadata may include data such as, but not limited to, scene information and camera identification information. Additionally, in some embodiments, the metadata may also include timing information such as, but not limited to, a timing offset value, a timestamp ID and session ID.

In various embodiments, the synchronizing of the plurality of video content streams may further include determining in real time the appearance of the code image in the plurality of video content streams, for example, using the metadata provided by the at least one syncing device.

In various embodiments, a user may control the at least one syncing device. For example, the user may control the at least one syncing device using a master syncing device. Further, the master syncing device may be communicatively coupled to other syncing devices of the plurality of syncing devices via a personal area network such as Bluetooth or Wi-Fi.

Also disclosed is an apparatus for facilitating synchronization of a plurality of video content streams captured from multiple angles. The apparatus may include one or more computer processors and a display coupled to the one or more computer processors. A memory communicatively coupled with the one or more computer processors may include a code display module configured to operate the one or more computer processors to display a code image on the display. Further, the code image may be visually captured on the plurality of video content streams. The memory may further include a metadata generation module to generate metadata including time information. Furthermore, the one or more computer processors may be communicatively coupled to a communication module configured to communicate the metadata to at least one external device. Further, the code image and the metadata generated by the one or more computer processors may provide information that may be used to synchronize the plurality of video content streams. Further, in various embodiments, the code image may include identification of at least one of a camera and a scene.

In some embodiments, a director may control operation of the syncing devices. Further, in some embodiments, the director may control a master syncing device which in turn may be used to control other syncing devices deployed in the multi-camera setup.

Further, the content from each of the first camera and the second camera may be sent to the director. Furthermore, in some embodiments, the director may additionally receive metadata generated by the syncing devices. In some embodiments, the metadata may include an identification of the camera and an identification of the scene.

Thereafter, the director may stream all the video content captured by the plurality of video cameras into a Video Production Software. In an instance, the video production software may be a Non-Linear Editing (NLE) Software. The NLE software may be configured to scan the content stream for frames containing the code image displayed by the syncing devices. Thereafter, the NLE software may read the metadata to determine where in ‘real time’ the code image appeared. Accordingly, the NLE software may align the content using the detected image frames containing the code image in content stream and, in some embodiments, based further on metadata received from the syncing devices.

Both the foregoing brief overview and the following detailed description provide examples and are explanatory only. Accordingly, the foregoing brief overview and the following detailed description should not be considered to be restrictive. Further, features or variations may be provided in addition to those set forth herein.

For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates block diagram of an operating environment consistent with the present disclosure.

FIG. 2A illustrates a syncing device configured to display code images for synchronizing multiple video content streams according to various embodiments.

FIG. 2B illustrates an exemplary code image displayed by the syncing device according to various embodiments.

FIG. 2C illustrates an exemplary code image displayed by the syncing device according to various embodiments.

FIG. 3 illustrates a syncing device configured to display code images for synchronizing multiple video content streams according to various embodiments.

FIG. 4 illustrates an exemplary use case of the syncing device in a multi-angle video content capture environment according to various embodiments.

FIG. 5 illustrates an exemplary use case of the syncing device in a multi-angle video content capture environment according to various embodiments.

FIG. 6 illustrates an exemplary use case of a master syncing device in a multi-angle video content capture environment according to various embodiments.

FIG. 7 illustrates an exemplary use case of a master syncing device in a multi-angle video content capture environment according to various embodiments.

FIG. 8 illustrates an exemplary platform for synchronizing the plurality of video content streams by a Non Linear Editing Software according to various embodiments.

FIG. 9 illustrates an exemplary video content stream with code images captured by a camera device according to various embodiments.

FIG. 10 illustrates an exemplary synchronous view of the multiple video content streams with code images according to various embodiments.

FIG. 11 illustrates a flowchart of a method of synchronizing video content streams based on the code images according to various embodiments.

FIG. 12 illustrates a flowchart of a method of synchronizing video content streams based on the code images according to various embodiments.

FIG. 13 illustrates a flowchart of a method of synchronizing video content streams based on the code images according to various embodiments.

FIG. 14 is a block diagram of a system including a syncing device for performing methods of FIG. 11-13.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of film production, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

In some embodiments, the disclosure relates to a method of facilitating synchronization of a plurality of video streams captured from multiple angles. The synchronization of the plurality of video streams may be enabled by a syncing device. In some embodiments, the syncing device may be a tablet or any other mobile device that may be programmed to generate a code image to be used for syncing multi-angle content captured from a plurality of cameras. In some other embodiments, the syncing device may include on-scene accessories such as strobe light. Further, the plurality of cameras used for capturing the video streams may be, for example, but not limited to, film based cameras and digital cameras. Furthermore, the syncing device may be placed in front of a first camera during the first camera's recording session. Further, the syncing device may display a code image which may be captured by the first camera. The code image may appear on the screen of the syncing device and may be recorded into the first content stream captured by the first camera. Similarly, the syncing device may then be placed in front of a second camera during the second camera's recording session. Further, the syncing device may display an updated code image that appears on the screen of the syncing device. Subsequently, the second camera may capture the updated code image in the second content stream.

In some embodiments, the syncing device may display the same code image to each of the first camera and the second camera. Further, in some embodiments, the code image generated by the syncing device may be a particular pattern of flashes or a complex visual. The complex visual may include a 2 dimensional barcode such as a QR code.

In some cases, a single syncing device may be used with multiple cameras by introducing the syncing device at different instances of time during the filming. In some other instances, a single syncing device may be placed in the field of view of multiple cameras so that it is captured by all the cameras. Accordingly, the code image generated by the syncing device may be captured by all the cameras simultaneously.

In some embodiments, multiple syncing devices may be used in the multi-angle camera setup. In this case, the multiple syncing devices may first be synced together. The syncing of the multiple syncing devices may be achieved, for example, by connecting the syncing device through a personal area network, such as Bluetooth or Zig-Bee. Further, in this setup, all the syncing devices may be placed in front of their corresponding cameras at different times. However, in some instances, the syncing devices may be placed in front of the corresponding cameras at the same time.

In some embodiments, a director may control operation of the syncing devices. Further, in some embodiments, the director may control a master syncing device which in turn may be used to control other syncing devices deployed in the multi-camera setup.

Further, the content from each of the first camera and the second camera may be sent to the director. Furthermore, in some embodiments, the director may additionally receive metadata generated by the syncing devices. In some embodiments, the metadata may include an identification of the camera and an identification of the scene.

Thereafter, the director may stream all the video content captured by the plurality of video cameras into a Video Production Software. In an instance, the video production software may be a Non-Linear Editing (NLE) Software. The NLE software may be configured to scan the content stream for frames containing the code image displayed by the syncing devices. Thereafter, the NLE software may read the metadata to determine where in ‘real time’ the code image appeared. Accordingly, the NLE software may align the content using the detected image frames containing the code image in content stream and, in some embodiments, based further on metadata received from the syncing devices.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

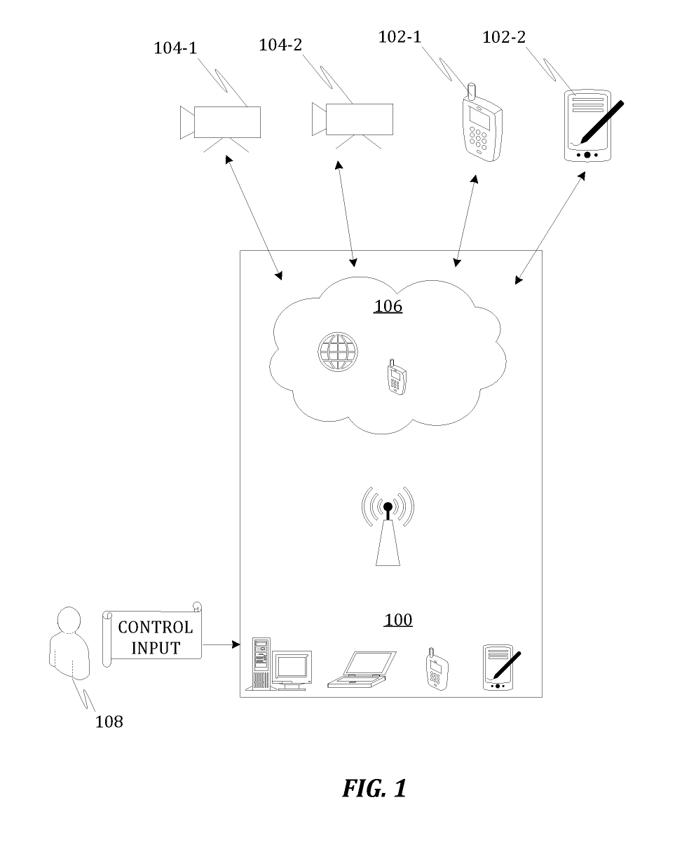

FIG. 1 illustrates one possible operating environment through which a platform consistent with embodiments of the present disclosure may be provided. The operating environment may comprise methods, systems, and devices collectively referred to as a platform 100. The platform 100 may include one or more syncing devices 102, such as 102-1 and 102-2 and a plurality of cameras 104 such as 104-1 and 104-2. In some embodiments, syncing device 102-1 and 102-2 may be remotely operated by syncing devices 102. For example, syncing devices 102-1 may be a color coded strobe light remotely operated by syncing devices 102.

Examples of the plurality of cameras 104 include, but are not limited to, for example, still image camera, video camera, smart-phone, tablet computer, laptop computer, sound recorder and thermal imager. Further, a camera device of the plurality of cameras 104 may be replaced by a content capturing means configured to capture content.

In general, the content may include a representation of one or more physical characteristics. For example, in some embodiments, the content may include visual content. Accordingly, the content may be a representation of optical characteristics such as, but not limited to, reflectance, transmittance, luminance and radiance. For instance, visual content corresponding to a scene may include electronic representation, such as, for example, a digital representation, of reflectance of visible light from one or more objects in the scene as captured from two or more viewpoints. Accordingly, the plurality of cameras may be positioned at different spatial coordinates corresponding to the two or more viewpoints. Examples of content may include one or more of, but not limited to, image, video and audio. In various embodiments, the content may correspond to, but without limitation, one or more sensory modalities. The one or more sensory modalities may include visual modality, auditory modality, tactile modality, olfactory modality and gustatory modality.

In order to capture the content, the content capturing means may include one or more sensors configured for sensing one or more physical characteristics corresponding to the content. For example, the content capture means may include an image capturing device configured for sensing electromagnetic radiation in a scene and generating a corresponding electronic representation. Further, the image capturing device may be configured for sensing electromagnetic radiation corresponding to one or more wavelength bands. As an example, the image capturing device may be a video camera configured for sensing electromagnetic radiation in the visible spectrum. As another example, the image capturing device may be configured for sensing electromagnetic radiation in the infrared spectrum. In another embodiment, the content capturing means may include a microphone configured for sensing sound waves and generating a corresponding electronic representation such as, for example, a digital representation.

Moreover, the platform 100 may include a networking environment for facilitating communication between the one or more syncing devices 102 and the plurality of cameras 104. By way of non-limiting example, the platform 100 may be interconnected using a network 106. In some embodiments, the network 106 may comprise a Local Area Network (LAN), a Bluetooth network, a Wi-Fi network and a cellular communication network. In other embodiments the platform 100 may be hosted on a centralized server, such as, for example, a cloud computing service. A user 108 (e.g., director) may access platform 100 through a software application. The software application may be embodied as, for example, but not be limited to, a website, a web application, a desktop application, and a mobile application compatible with a one or more electronic devices. One possible embodiment of the software application may be provided by a syncing application included on electronic devices such as smart phones and tablet computers, wherein the syncing application may be configured to facilitate synchronization of multiple video content streams.

The platform 100 may further include additional computing devices in operative communication with one or more of the one or more syncing devices 102 and the plurality of cameras 104. Although the present disclosure refers to various functions and operations performed by particular components of the platform (e.g., a syncing device or camera device), it should be understood that some platform components may be interchanged with others, and/or, where necessary, combined with other components to perform the functions and operations intended.

As will be detailed with reference to FIG. 1 below, an electronic device through which the platform 100 may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The platform 100 may be configured to communicate with each of the devices such as the one or more syncing devices 102 and the plurality of cameras 104 over the network 106. Further, the platform 100 may be configured to provide a user interface to the user 108. Accordingly, the user 108 may interact with the platform 100 in order to initiate display of one or more code images by the one or more syncing devices 102. For example, the platform 100 may display a GUI to the user 108 in order to select one or more of the one or more syncing devices 102 to participate in a collaborative recording session and synchronization of content. Further, the GUI may enable the user 108 to enter commands to initiate a display of one or more code images in the selected one or more of the syncing devices 102. Accordingly, a command entered by the user 108 may then be transmitted to the selected one or more syncing devices 102 over the network 106. Upon receiving the command, the selected one or more syncing devices 102 may display one or more code images which may be captured by the plurality of cameras 104. Subsequently, the content captured by the plurality of cameras 104 may be transferred to the platform 100 over the network 106. The platform 100 may host Non Linear Editing (NLE) Software, which may be used to synchronize the video content captured by the plurality of cameras 104 based on the one or more code images. Further, the platform 100 may include means, such as, for example, a communication interface, capable of communicating with the one or more syncing devices 102.

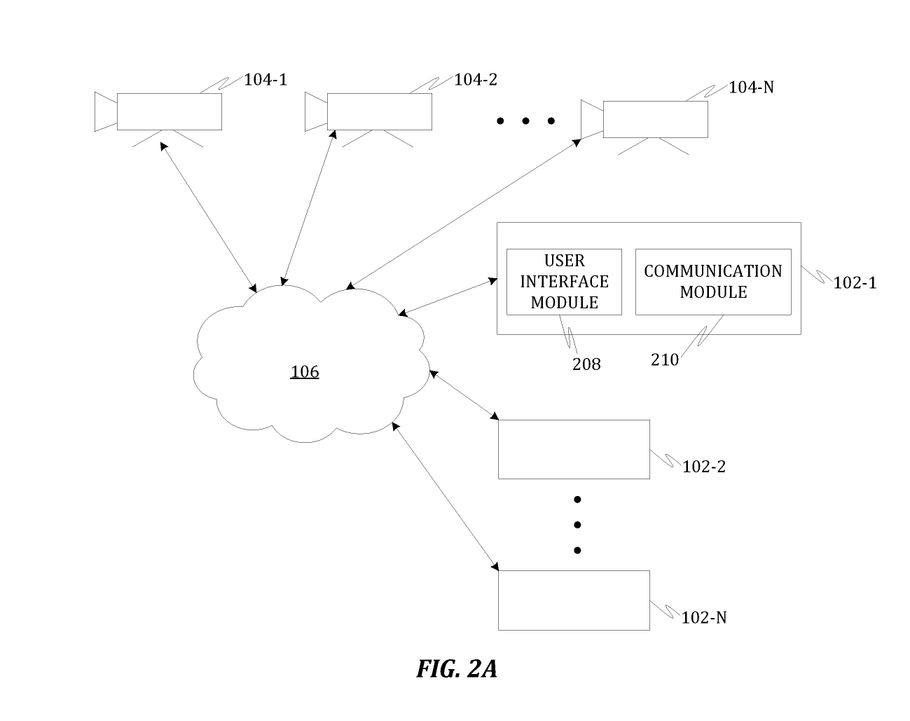

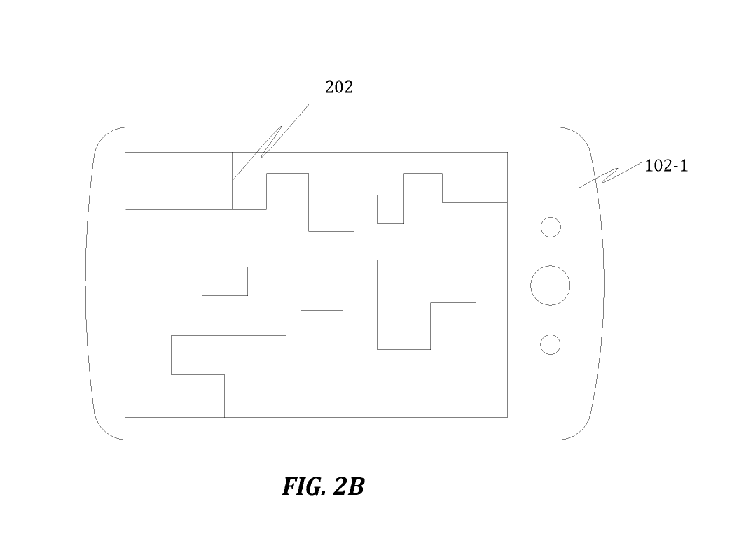

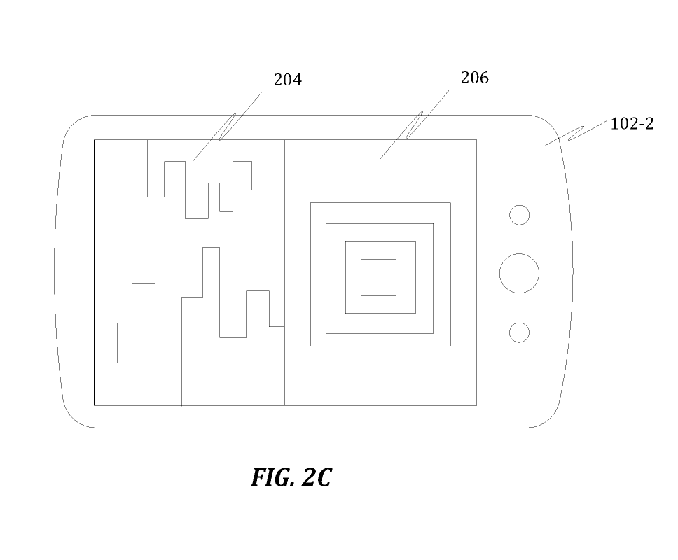

Referring to FIG. 2A, the one or more syncing devices 102 (individual syncing devices are referred to as 102-1, 102-2 . . . 102-N) configured to be used for generating one or more code images for synchronizing content captured using the plurality of cameras 104 (individual cameras are referred to as 104-1, 104-2 . . . 104-N) is illustrated. Each syncing device in the one or more syncing devices 102 may include a code image generating means configured to generate and display a code image. The code image may be a complex visual. An example code image 202 generated by the syncing device 102-1 is illustrated in FIG. 2B. In some embodiments, a syncing device in the one or more syncing devices 102 may be configured to display a plurality of code images simultaneously. An example of a plurality of code images 204 and 206 simultaneously generated by the syncing device 102-2 is illustrated in FIG. 2C. In another example (not shown in figures), the syncing device 102-2 may display a series of flashes in one portion of the display and an encoded image in another portion of the display. Further, the one or more syncing devices 102 may be configured to generate code images which may be captured in the content using the plurality of cameras 104.

Each of the syncing devices 102 may further include a user interface module and a communication module. For example, the syncing device 102-1 may further include a user interface module 208 configured to receive an indication of a control-input from the user 108. Accordingly, the user interface module 208 may allow the user 108 to directly interact with the syncing device 102-1. In general, the user interface module 208 may be any means configured to receive input from the user 108. In various embodiments, the user interface module 208 may include a Graphical User Interface (GUI) presented on a display device, such as, a touch-screen. In another embodiment, the user interface module 208 may include an input device such as, but not limited to, a keyboard, a mouse, a touch-pad, a stylus, a digital pen, a voice recognition device, a gesture recognition device and a gaze detection device. In some embodiments, the user interface module 208 may be implemented using one or more of hardware and software. Examples of hardware include, but are not limited to, sensors and processors.

In various embodiments, the indication of the control-input may include one or more of a touch on a GUI corresponding to the control-input, a depression of a key corresponding to the control-input, a mouse click on a GUI element corresponding to the control-input, a gesture corresponding to the control-input, a voice command corresponding to the control-input, a gesture corresponding to the control-input and a gaze corresponding to the control-input.

In general, the control-input may represent any information that may be used to control a state of the one or more syncing devices 102. For instance, the control-input may represent information about which operation is to be performed, conditions under which the operation is to be performed and how the operation is to be performed. As an example, the control-input may represent information that may be used to enable or disable a functionality of the one or more syncing devices 102. For example, the control-input may be used to disable the one or more syncing devices 102 after displaying the one or more code images, to ensure that no unnecessary visual artifact may be captured in corresponding video streams. As another example, the control-input may represent information that may be used to trigger the one or more syncing devices 102 to perform one or more operations. Accordingly, the control-input may include an operation indicator corresponding to the one or more operations. Examples of the one or more operations include, but are not limited to, generating a code to be displayed on the screen of the syncing device 102, encoding one or more metadata into the code displayed on the screen, displaying a code image at a particular point in time, connecting to one or more syncing devices 102 such as the syncing device 102-1, transmitting a code image to one or more other syncing devices 102 and displaying the code image so that the code image is captured simultaneously by the plurality of cameras 104.

Further, the control-input may represent information that indicates a context in which the one or more operations are to be performed. The context may generally include values corresponding to situational variables such as, but not limited to, time, place and one or more environmental conditions corresponding to the plurality of cameras 104. For example, the context may include range of coordinates of a region. As another example, the context may include a range of time values. Accordingly, in various embodiments, the one or more syncing devices 102 may be triggered to perform the one or more operations at the range of time values. As yet another example, the context may include a predetermined state of one or more sensors included in the one or more syncing devices 102. The one or more sensors may include, but are not limited to, accelerometer, gyroscope, magnetometer, barometer, thermometer, proximity sensor, light meter and decibel meter. Further, the control-input may also include one or more rules that may specify one or more conditions and corresponding to one or more actions to be performed by the one or more syncing devices 102. For example, a rule may specify the one or more syncing devices 102 to display a code image at a particular instance in time. As another example, a rule may specify initiation of display of a code image by each of the syncing device 102 when the plurality of cameras 104 are capturing a video content.

Furthermore, in various embodiments, the one or more syncing devices 102 may form a network, such that they may be controlled collectively using the network. For example, the control-input may indicate that the one or more syncing devices 102 communicate with each other over the network to coordinate and display one or more code images at one or more time instants.

Additionally, in various embodiments, the syncing device 102-1 may also include a communication module 210 configured to communicate data among one or more of the platform 100, other syncing devices of the one or more syncing devices 102 and the plurality of cameras 104. Further, the communication module 210 may be configured to communicate data over one or more communication channels 106. Accordingly, each of the one or more syncing devices 102 and the plurality of cameras 104 may also include one or more communication modules configured to communicate over the one or more communication channels 106.

The one or more communication channels 106 may include one or more of a common local-area-network connection, a Wi-Fi connection, and a Bluetooth connection. For example, the communication module 210 may include a Bluetooth transceiver configured to perform one or more of transmission and reception of data over a Bluetooth communication channel. As yet another example, the communication module 210 may include a network interface module configured for communicating over a packet switched network such as, for example, the Internet. In various embodiments, each of the platform 100, the one or more syncing devices 102 and the plurality of cameras 104 may be configured to communicate over an ad-hoc wireless network. Accordingly, the platform 100 may be configured to transmit a request to the one or more syncing devices 102 and the plurality of cameras 104 to form the ad-hoc wireless network.

In various embodiments, the communication of data may include wireless transmission of the control-input to the one or more syncing devices 102. Accordingly, the communication module 210 included in the syncing device 102 may be configured to perform one or more of transmission and reception of electromagnetic waves.

In various embodiments, the communication module 210 may be configured for wireless reception of the control-input at the syncing device 102-1. In another embodiment, the communication module 210 may be further configured for wireless transmission of the received control-input to another syncing device such as the syncing device 102-2. A communication module of the syncing device 102-2 may be further configured for wireless transmission of the received control-input to yet another syncing device such as the syncing device 102-3. In yet another embodiment, the communication module 210 may be configured to communicate data to a server (not shown).

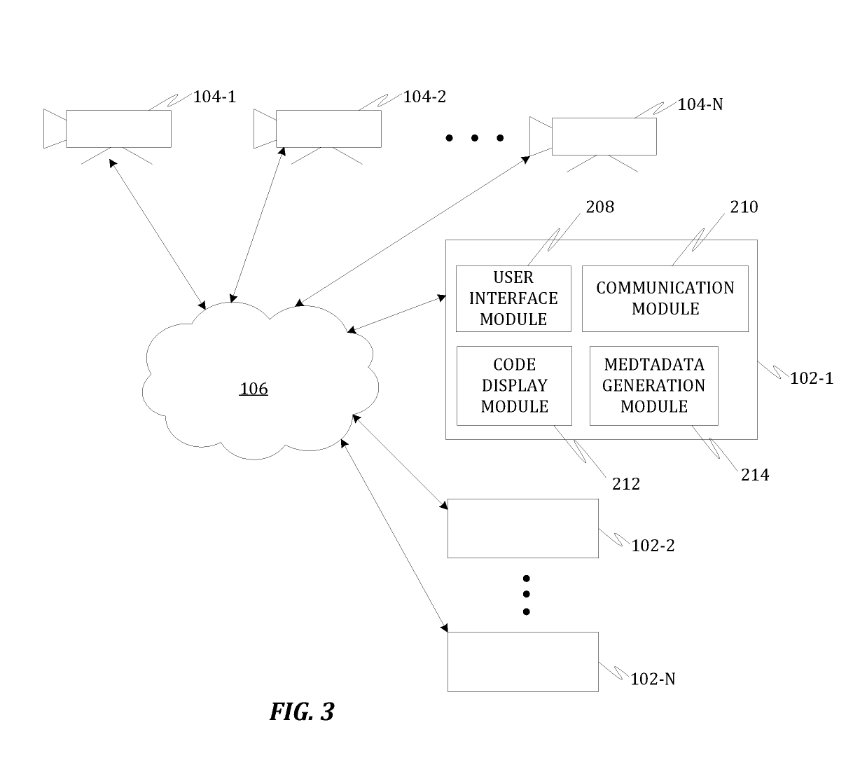

FIG. 3 illustrates an exemplary syncing device 102-1 in accordance with various embodiments of the invention. The syncing device 102-1 may further include a code display module 212 and a metadata generation module 214. The code display module 212 may be configured to display at least one code image 202 on a display of the syncing device 102-1, as illustrated in FIG. 2B. The code image may include, but is not limited to, a series of flashes, a two dimensional barcode and an encoded image. Further, the code display module 212 may actuate the display of the syncing device 102-1 in such a manner that at least one code image may be visually captured on the plurality of video content streams captured by the plurality of the cameras 104. Further, the code display module 212 may be configured to automatically determine an appropriate time instance of actuating the display of the syncing device 102-1 so that the code image may be captured in the plurality of video content streams. In some embodiments, the code display module 212 may use at least one camera device associated with the syncing device 102-1 in order to determine if the code image displayed by the syncing device 102-1 is captured by one or more cameras in the plurality of the cameras 104. For example, the code display module 212 may capture an image from at least one of a front camera and a rear camera associated with the syncing device 102-1 to identify at least one camera in the plurality of the cameras 104 (such as the camera 104-1) in the field of view of one of the front camera and the rear camera associated with the syncing device 102-1. In case the code display module 212 identifies one or more such camera devices in the plurality of the cameras 104 configured for capturing video content, the code display module 212 may actuate the display of the syncing device 102-1 to display the code image.

In some embodiments, the code display module 212 may be configured to display a series of flashes as the code image. The series of flashes may be of a desired color as configured by the director. The series of flashes may be spread across a time interval. In some cases, the series of flashes may be actuated at random time instances within a time interval.

In some other embodiments, the code display module 212 may be configured to display an encoded image as a code image. The encoded image may be provided by the metadata generation module 214. The encoded image may be a 1 dimensional barcode, a 2-dimensional barcode and a Manchester encoded image. In some embodiments, the code display module 212 may be configured to display a plurality of code images simultaneously. For example, the code display module 212 may display code images in different portions of the display screen, as shown in FIG. 2C.

In some embodiments, the code display module 212 may also be configured to display the code image in a particular resolution and dimension based on a distance between a syncing device of the one or more syncing devices 102 and a corresponding camera of the plurality of cameras 104. For example, the code display module 212 may determine an appropriate dimension and resolution of the code image to be displayed by capturing images of one or more cameras of the plurality of the cameras 104 utilizing at least one of the front camera and the rear camera associated with the syncing device 102-1. The code display module 212 may compute the distance between the syncing device 102-1 and a camera of the plurality of cameras 104 based on a size of the camera in the images captured by at least one of the front camera and the rear camera associated with the syncing device 102-1.

In some embodiments, the syncing device 102-1 may include code image generation module (not shown in figures). The code image generation module may be configured to generate a code image based on one or more parameters. The one or more parameters may include, but are not limited to, a time stamp, an identification of a syncing device such as the syncing device 102-1, an identification of a scene and an identification of a location. In an embodiment, the code image generation module may encode timestamp ID and session ID into a 2 dimensional barcode such as a QR code. Thereafter, the code image, in this case the QR code, may be displayed on the display of the syncing device 102-1.

In some other embodiments, the code image generation module may generate a code image based on the control-input received by the syncing device 102-1. For example, the control-input may indicate a type of code image to be generated. The code image generation module may encode one or more parameters into the code image. As a result, the code image generated by the code image generation module may represent a metadata associated with the content that may be captured by the plurality of cameras 104. The code image generated by the code image generation module may be used by the director to synchronize the plurality of video content streams captured by the plurality of camera 104.

In some embodiments, the metadata generation module 214 may be configured to generate metadata including timing information associated with the plurality of video content streams. In some embodiments, the information generated by the metadata generation module 214 may be incorporated in the code image generated by the code image generation module (not shown in figures). Further, the metadata may be used to synchronize the plurality of video content streams. In some other embodiments, the information generated by the metadata generation module 214 may be obtained by a Non-Linear Editing (NLE) software which may be used for synchronizing the plurality of video content streams.

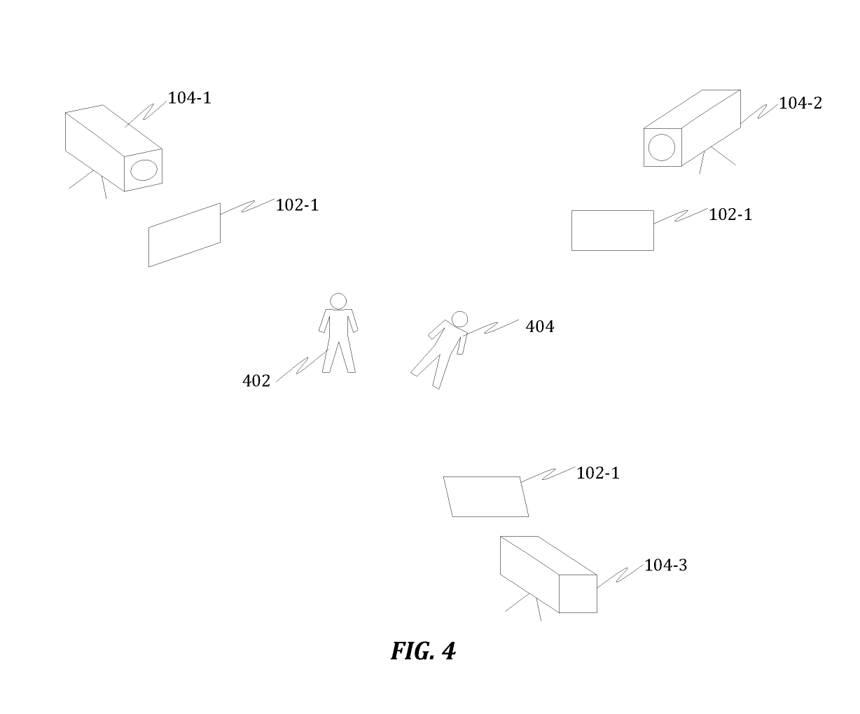

FIG. 4 illustrates an exemplary use case of the syncing device 102-1 in a multi-angle video content capture environment according to various embodiments. As shown, multiple cameras 104-1, 104-2 and 104-3 may be employed to capture multiple video content streams of a scene involving two people 402 and 404. The syncing device 102-1 may be placed within the field of view of the cameras 104-1, 104-2 and 104-3 capturing the multiple video content streams. Further, in this case, the syncing device 102-1 may be sequentially introduced in the field of view of the multiple cameras 104-1, 104-2 and 104-3. Furthermore, the code image displayed by the syncing device 102 may be constant for all the video content streams, in some embodiments. Alternatively, in some other embodiments, the syncing device 102-1 may display an updated code for each of the multiple cameras 104-1, 104-2 and 104-3 capturing the multiple video content streams.

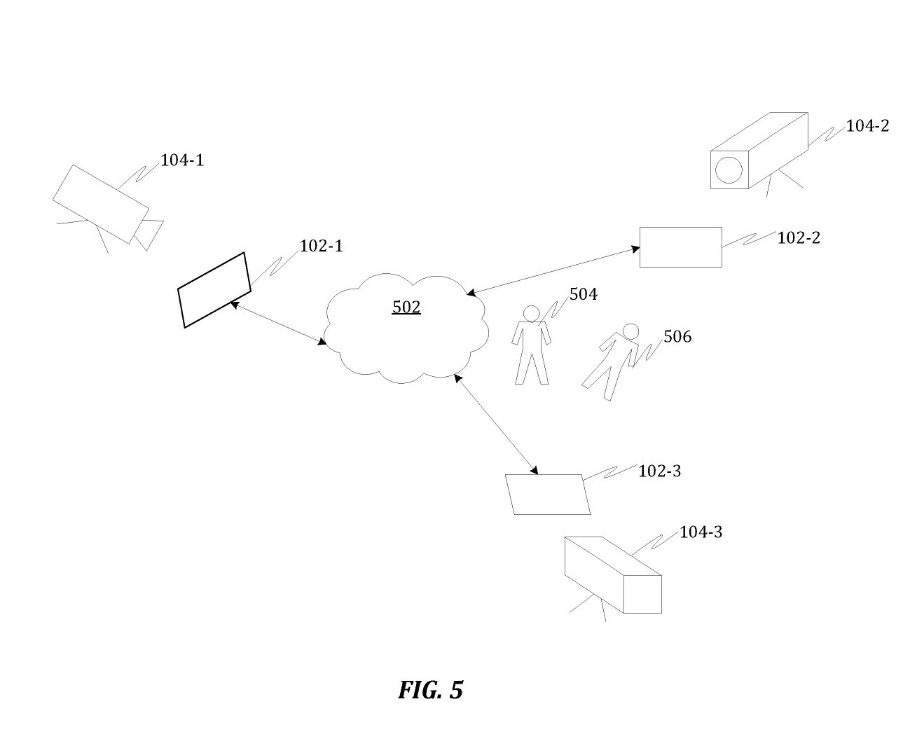

FIG. 5 illustrates an exemplary use case of using a plurality of syncing devices for synchronizing multiple video content streams, in accordance with an embodiment. As illustrated, the syncing devices 102-1, 102-2 and 102-3 may be connected through a network 502. The network 502 may include an ad-hoc network such as Bluetooth or PAN. As shown, multiple cameras 104-1, 104-2 and 104-3 may be employed to capture multiple video content streams of a scene involving two people 504 and 506.

The syncing devices 102-1, 102-2 and 102-3 may be placed such that they are in the field of view of the cameras 104-1, 104-2 and 104-3. Thereafter, the syncing devices 102-1, 102-2 and 102-3 may be configured to display one or more code images to be captured by the cameras 104-1, 104-2 and 104-3. Accordingly, the cameras 104-1, 104-2 and 104-3 may capture the one or more code images in the respective captured video content streams.

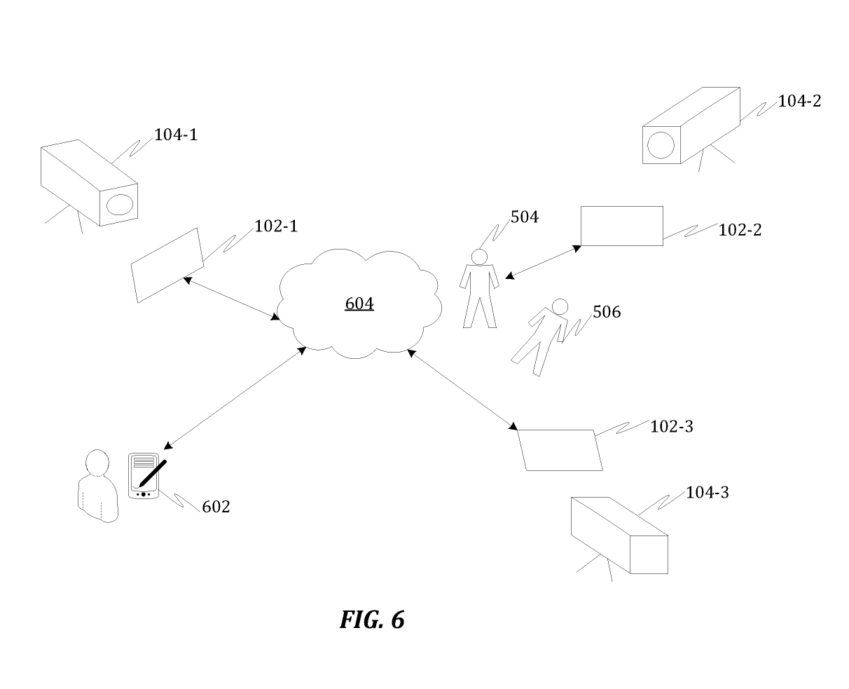

In some embodiments, the syncing devices 102-1, 102-2 and 102-3 may be controlled and coordinated using a master syncing device 602, as illustrated in FIG. 6. The master syncing device 602 may be configured to include capabilities in addition to the capabilities of the syncing devices 102-1, 102-2 and 102-3. In an embodiment, the master syncing device 602 may be used by the director to control the operation of one or more syncing devices 102-1, 102-2 and 102-3. The additional capabilities of the master syncing device 602 are explained in the forthcoming embodiments.

In some embodiments, the master syncing device 602 may include a syncing device registration module, a syncing device coordination module and a syncing device dissociation module. The various modules of the master syncing device 602 may be in the form of a software application. In an exemplary embodiment, the application may be presented to the director via a Graphical User Interface (GUI). In one embodiment, the director may provide an input for registering one or more of the syncing devices 102-1, 102-2 and 102-3. The master syncing device 602 may connect to one or more of the syncing devices 102-1, 102-2 and 102-3 via an ad-hoc network 604 such as a Personal Area Network (PAN). The syncing device registration module may scan the network for any syncing devices such as one or more syncing devices 102-1, 102-2 and 102-3. Thereafter, the syncing device registration module may register with one or more of the syncing devices 102-1, 102-2 and 102-3 by issuing a registration code. Upon successful registration of one or more of the syncing devices 102-1, 102-2 and 102-3, the master syncing device 602 may be able to issue one or more control-inputs to one or more of the syncing devices 102-1, 102-2 and 102-3. The control-inputs may cause, for example, initiating a display of a code image on a display of the one or more syncing devices 102-1, 102-2 and 102-3.

In some embodiments, syncing device coordination module may be configured to coordinate the operation of the registered syncing devices of the one or more syncing devices 102-1, 102-2 and 102-3. In an embodiment, the syncing device coordination module may issue control-inputs to the registered syncing devices to display a code image at a particular time instance. Further, the syncing device coordination module may provide control-inputs to the registered syncing devices to display a particular type of code image. In some further embodiments, the syncing device coordination module may be configured for issuing control-inputs for initiating operations such as, but not limited to, displaying a code image simultaneously by all the registered syncing devices, displaying the code image by the registered syncing devices at predefined intervals, displaying a type of code image, capturing an image of a camera of the plurality of cameras 104 and the like.

In some embodiments, the master syncing device 602 may include a syncing device dissociation module. The syncing device dissociation module may be configured to deregister one or more registered syncing devices. In an embodiment, the user may choose to deregister or deactivate registered syncing devices using the GUI.

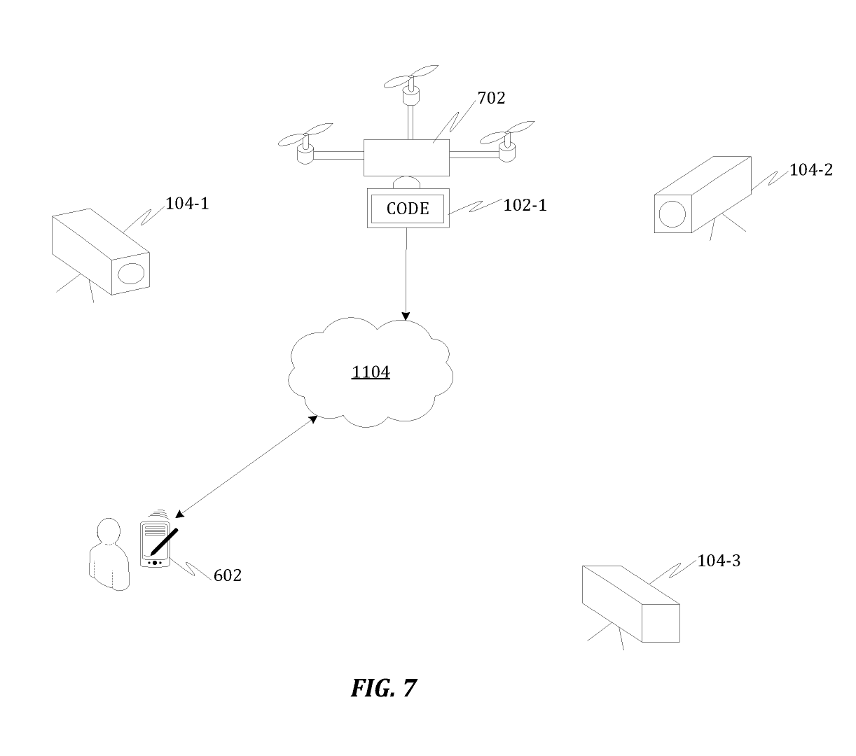

In some additional embodiments, the master syncing device 602 may be configured for controlling one or more peripheral devices 702, as illustrated in FIG. 7. The peripheral devices 702 may include, but not limited to, an electric toy car, an unmanned aerial vehicle and a remote controlled instrument. The required software modules for controlling the peripheral devices may be installed in the memory unit of the master syncing device 602. The peripheral devices 702 may be employed for physically transporting the syncing device 102-1 into the field of view of the one or more cameras 104-1, 104-2 and 104-3 capturing the multiple video content streams. For example, a remote controlled drone may be altered to secure a syncing device 102-1 and the drone may be controlled remotely by the master syncing device 602 for positioning the syncing device 102-1 in the field of view of the one or more cameras 104-1, 104-2 and 104-3 which may be capturing multiple video content streams.

In an exemplary embodiment, the multiple content streams captured by the cameras 104-1, 104-2 and 104-3 may be collected using a Non Linear Editing (NLE) software.

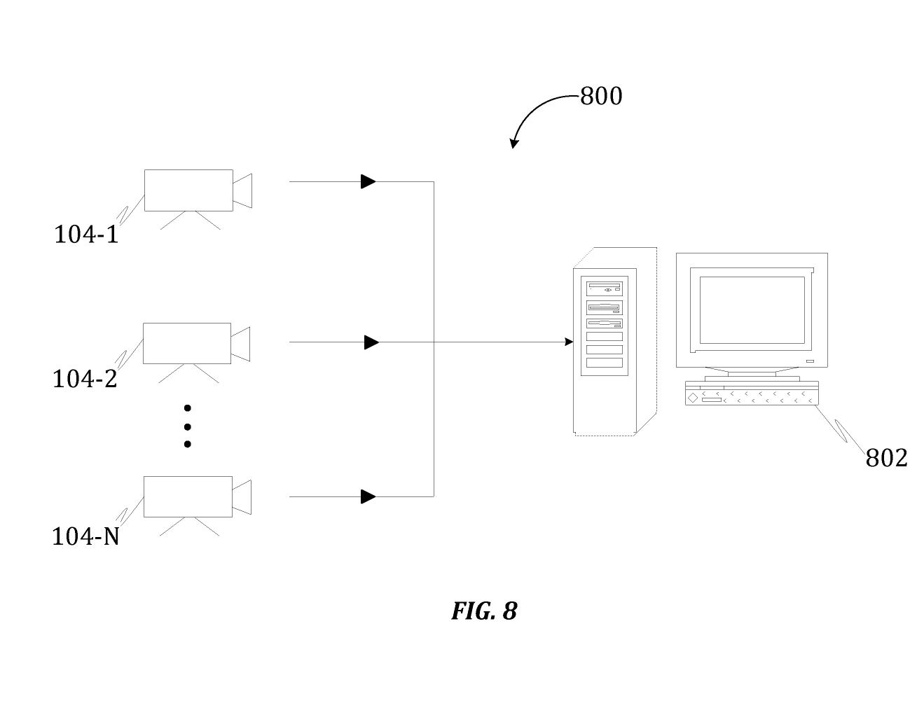

FIG. 8 illustrates an exemplary embodiment of an apparatus 800 for synchronizing a plurality of the video content streams. The apparatus 800 may include a computing device 802. NLE software may be installed in the memory module of the computing device 802. Further, the user 108 may operate the computing device 802. The NLE software may be configured to obtain one or more video content streams from the plurality of cameras 104 (including cameras 104-1, 104-2 . . . 104-N).

In an embodiment, the NLE software may be installed in the one or more syncing devices 102. The NLE software may be operated by the director for synchronizing the multiple video content streams captured by the plurality of cameras 104. Further, the NLE software may be configured to scan the frames of the multiple video content streams for code images generated by the one or more syncing devices 102. Further, the NLE software may be configured for decoding the code image and extract one or more metadata encoded in the code image. In an exemplary instance, the NLE software may be configured to identify and decode one or more variations of the code images. Further, the NLE software may be configured to synchronize the plurality of video content streams based on the metadata obtained from the code images. In another exemplary instance, the NLE software may be configured to receive metadata directly from the one or more syncing devices 102. In an instance, the metadata received may include timing information associated with the synchronization of the multiple video content streams. In an instance, the one or more syncing devices 102 may connect to the computing device 802 through a wired or a wireless communication network and transfer the metadata information directly to the NLE software. In another instance, the metadata from the one or more syncing devices 102 may be transferred to a cloud infrastructure and the NLE software may access the metadata information directly from the cloud infrastructure. In some embodiments, the NLE software may configured to use inter-frame time-shifting methods for synchronizing the multiple video content streams with an accuracy of one frame.

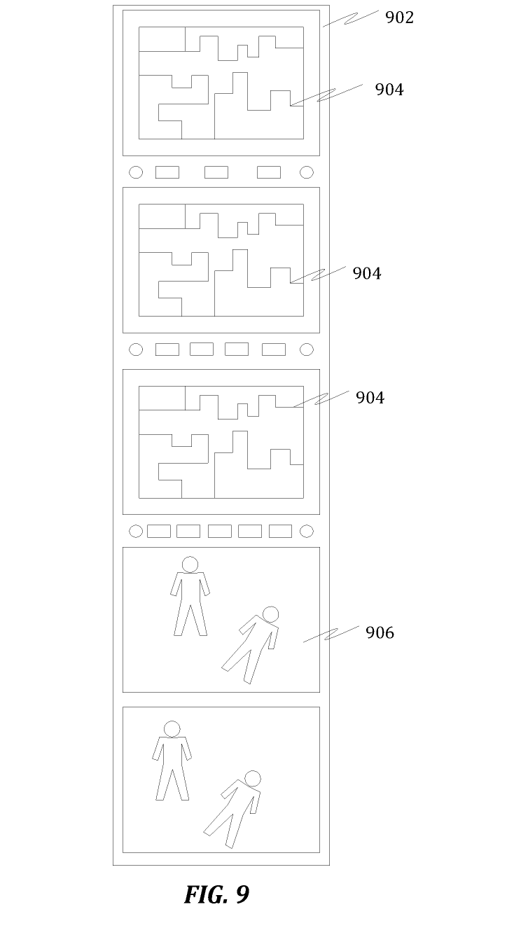

FIG. 9 illustrates an exemplary video content stream 902 including a code image 904 displayed by a syncing device of the one or more syncing devices 102, in accordance with an embodiment. The video content stream 902 may be captured by one of the cameras of the plurality of cameras 104. As illustrated in FIG. 9, the first three frames of the video content stream 902 may include the code image 904. After the first three frames the video content stream 902 may include content such as, but not limited to, a scene of a movie or a live event. As illustrated, the content stream 902 may include a frame 906 where the actual video content may start. The code image 904 may also include metadata associated with the synchronization of the multiple content streams. The NLE software may be configured to identify the code image 904 and determine the metadata associated with the synchronization of the video content streams such as video content stream 902.

Alternatively, in some embodiments, a frame of the video content stream 902 may include each of visual content from a scene and the code image (not shown in figures). In other words, a frame may capture the one or more syncing devices 102 present in the field of view of a camera of the plurality of cameras while recording the scene. Accordingly, the NLE software may be configured to perform image analysis of the frame in order to detect a region of the frame containing the code image. Accordingly, the NLE software may extract the metadata from the code image and perform synchronization of the plurality of video content streams including the video content stream 902.

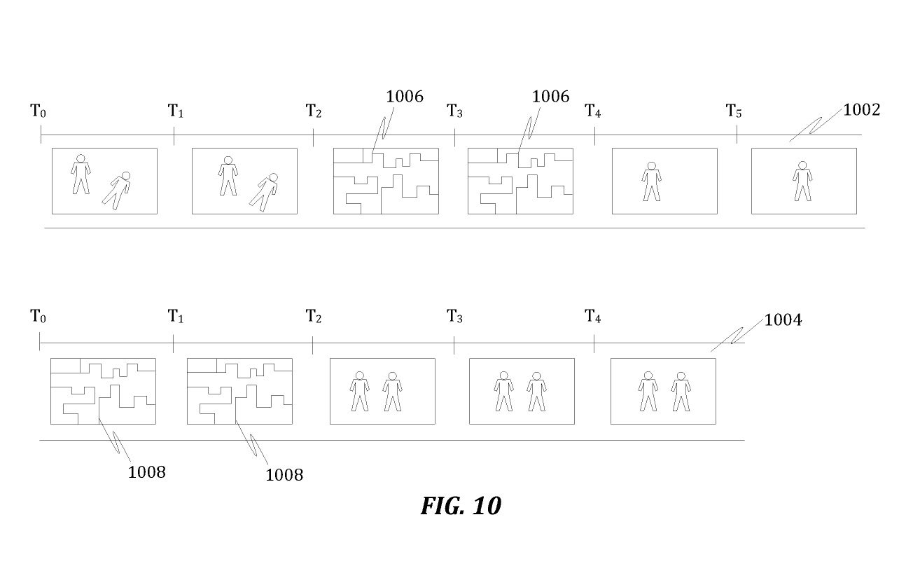

FIG. 10 illustrates exemplary video content streams 1002 and 1004 including code images 1006 and 1008 respectively, at different time instances of the video content streams 1002 and 1004, in accordance with an embodiment. The NLE software may be configured to obtain the video content streams 1002 and 1004 from two cameras in the plurality of cameras 104. The NLE software may display the video content streams 1002 and 1004 adjacent to each other as shown in FIG. 10. As shown, the video content stream 1002 includes the code image 1006 at time instances T2 and T3. Similarly, the video content stream 1004 includes the code image 1008 at time instances T0 and T1. In some embodiments, the code images may be captured at a same time instance in all the video content streams captured by the plurality of cameras 104. In some other embodiments, the video content streams may include different types of code images based on the setting of the one or more syncing devices 102. The NLE software may be configured to decode different types of code images displayed by the one or more syncing devices 102. Based on the metadata obtained after decoding the code image, such as the code images 1006 and 1008, the multiple video content streams, such as video content streams 1002 and 1004 are synchronized.

### III. PLATFORM OPERATION

In accordance with various embodiments, the user 108 of the one or more syncing devices 102 called a “director” may be allowed to control the display of the code image in the one or more syncing devices 102. Initially, the director may be presented with a GUI to register the one or more syncing devices 102 deployed in a multi-angle camera setup. Further, the one or more syncing devices 102 may be associated with the one or more of the plurality of cameras 104 that may be capturing multiple video content streams.

In one embodiment, the director may use a master syncing device 602 for controlling multiple syncing devices which are connected to the master syncing device 602.

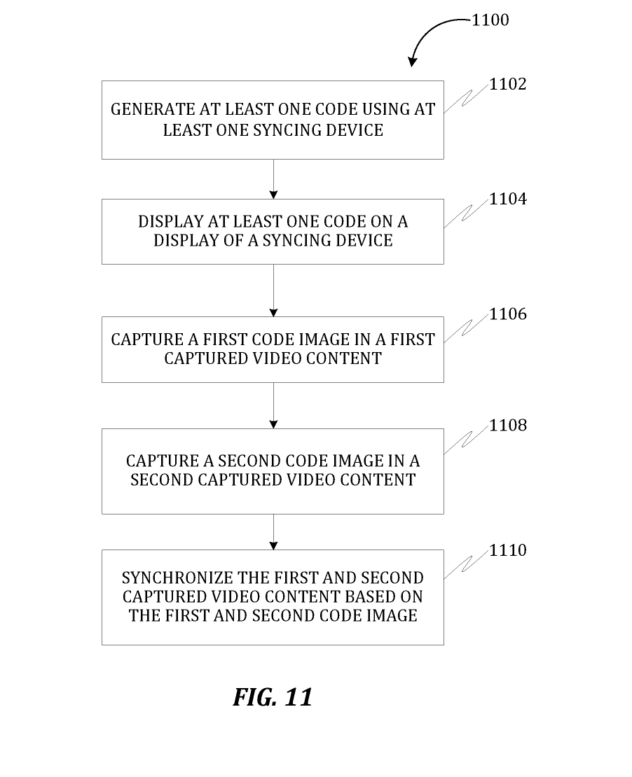

The following discloses the various operations platform components may be performed. Although methods of FIG. 11-13 have been described to be performed by various components of platform 100, it should be understood that any electronic device (e.g., syncing device 102, master syncing device 602) may be configured to perform the various stages of methods of FIG. 11-13 in any reasonable combination or, where feasible, individually. Furthermore, in some embodiments, different operations may be performed by different networked elements in operative communication.

FIG. 11 illustrates a flow chart 1100 of a method of synchronizing the multiple video content streams captured by the plurality of cameras 104 using one or more code images generated by the one or more syncing devices 102, according to various embodiments of the present disclosure. At step 1102, at least one code image may be generated using one or more syncing devices 102. In some embodiments, the one or more syncing devices 102 may be configured to generate code image such as, but not limited to, a one-dimensional barcode, a two-dimensional barcode, a sequence of flashes and a Manchester encoded image. The code image, such as code image 202 may be generated based on metadata. For example, the syncing device 102-1 may encode metadata such as, but not limited to, a camera identification, a scene identification, a time instant, a date and a location. In some further embodiments, the code image may include a timing information such as a current time, a relative time and a time offset. The metadata may be used by Non Linear Editing (NLE) software to synchronize multiple content streams captured by the plurality of cameras 104.

At step 1104, a first code image displayed by a syncing device (of the one or more syncing devices 102) may be captured in a first captured video content stream of the plurality of video content streams captured by the plurality of cameras 104. In some embodiments, the syncing device may be deployed in the field of view of a first camera device which captures video content. As a result, the code image displayed by the syncing device 102 may be captured by the first camera device. In some embodiments, the syncing device 102 may be programmed to display the code image at a predetermined time interval. Accordingly, the syncing device 102 may be captured in a first video stream captured by the first camera device at the predetermined time interval.

At step 1106, a second code image may be captured by a second video stream captured by a second camera device. The second code image may be generated by the syncing device 102 which was earlier captured by the first camera device. In an instance, the syncing device 102 may generate an updated code image. For example, the second code image may include, one or more of the identification of the second camera device, a second scene identification and a second location. Thereafter, the second code image generated by the syncing device 102 may be captured by the second camera device. Thereafter, each of the first camera device and the second camera device may connect to the computing device hosting the NLE software. The NLE software may identify the first and the second camera devices and receive the first and second video streams. Further, the NLE software may scan the first and the second video streams for code images. Thereafter, at step 1108, the first and second captured video content streams may be synchronized based on at least a part of the first and the second code images. Additionally, the NLE software may decode one or more metadata from the first and second images. Further, the NLE software may synchronize the first and the second video streams based on the metadata obtained from the first and the second code images.

In some embodiments, the syncing device 102 may generate a single code image for the first and the second camera devices. Further, the NLE software may synchronize the first and the second video streams based on the single code image.

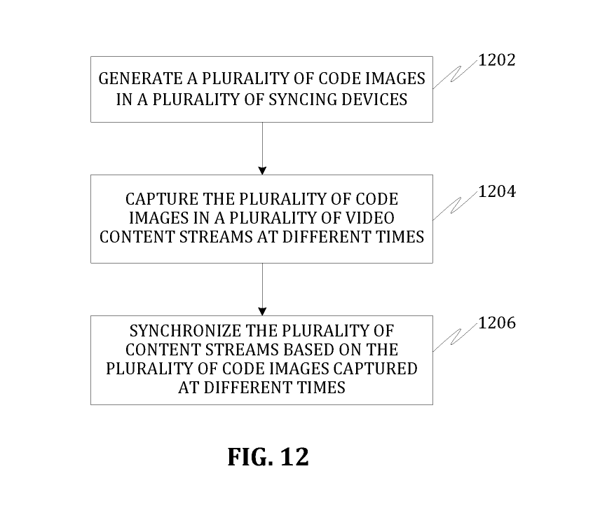

FIG. 12 illustrates an exemplary block diagram of the method steps for synchronizing a plurality of video content based on code images, in accordance with an embodiment of the present disclosure. At step 1202, a plurality of syncing devices 102 may be utilized to synchronize the video streams capture by the plurality of cameras 104. One camera device may capture more than one syncing device in a frame. Each of the plurality of the syncing devices 102 may generate a same code or different codes at any point in time. In an embodiment, the plurality of syncing devices 102 may generate different codes at different time instances. In some further embodiments, the plurality of syncing devices 102 may be configured to generate the same code image at different time instances. Further, the plurality of the syncing devices may be controlled using a master syncing device 602. The NLE software 804 may be configured to decode the multiple code images generated by the plurality of syncing devices 102 captured by the plurality of cameras 104. Subsequently, at step 1204, the plurality of cameras 104 may capture the code images generated by the plurality of syncing devices 102. Further, the plurality of syncing devices 102 may be configured to display the code at different time instances. In an instance, the director may use the master syncing device 602 for controlling the operation of the plurality of syncing devices 102. Accordingly, the master syncing device 602 may be used to coordinate the plurality of syncing devices for operations such as, but not limited to, type of code image to be displayed, time of display of the code image, duration of display of code image, brightness of the display and the colour of the code image.

Thereafter, the plurality of cameras 104 may be connected to the system 802 which may host the NLE software 804. The NLE software 804 may be configured to retrieve the plurality of video content streams from the plurality of cameras 104. Thereafter, the NLE software 804 may scan the plurality of video content streams for code images. Upon detection of code images, the NLE software 804 may decode the code images to extract one or more metadata required for synchronizing the plurality of video content streams. At step 1206, the plurality of video content streams may be synchronized based on the metadata decoded from the code images from the multiple video content streams. In an exemplary embodiment, the synchronization of the video content may be based on the scene numbers obtained from the code images. In another embodiment, the synchronization of the video content streams may be based on the identification of the camera devices. In some other embodiments, the plurality of video content may be synchronized based on a time value which may be obtained from the code images.

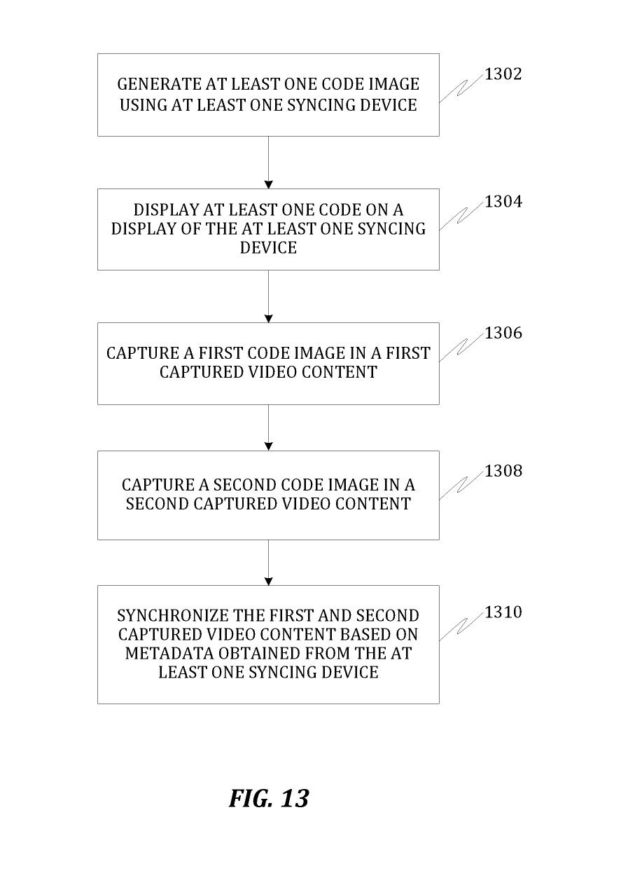

FIG. 13 illustrates an exemplary flow diagram of a method of synchronizing multiple video streams based on code images, in accordance with the embodiments of the present disclosure. The steps 1302 to 1308 are similar to the corresponding method steps 1102-1108 described in conjunction with FIG. 11. Further, at step 1310, the plurality of video streams from the plurality of camera devices 104 may be synchronized based on one or more metadata obtained from the one or more syncing devices 102. In an exemplary embodiment, the one or more syncing devices 102 may be connected to the computing device 802. Accordingly, the NLE software installed in the computing device 802 may obtain the metadata from the one or more syncing devices 102 connected to the computing device 802. In an exemplary embodiment, the metadata provided by the syncing devices may include, but is not limited to, a timing information, a session identifier, timing offset value and an event log. In some embodiments, the metadata provided by the syncing device may be encoded in the code images. In some cases, the metadata is transferred separately to the computing device 802.

While various embodiments of the disclosed methods and systems have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

### III. SYNCING DEVICE ARCHITECTURE

Platform 100 may be embodied as, for example, but not be limited to, a website, a web application, a desktop application, and a mobile application compatible with a computing device. The routing server may comprise, but not be limited to, a desktop computer, laptop, a tablet, or mobile telecommunications device. Moreover, the platform 100 may be hosted on a centralized server, such as, for example, a cloud computing service. Although methods of FIG. 11-13 have been described to be performed by the syncing device 102, it should be understood that, in some embodiments, different operations may be performed by different networked elements in operative communication with the syncing device 102.

Embodiments of the present disclosure may comprise a system having a memory storage and a processing unit. The processing unit coupled to the memory storage, wherein the processing unit is configured to perform the stages of methods of FIG. 11-13.

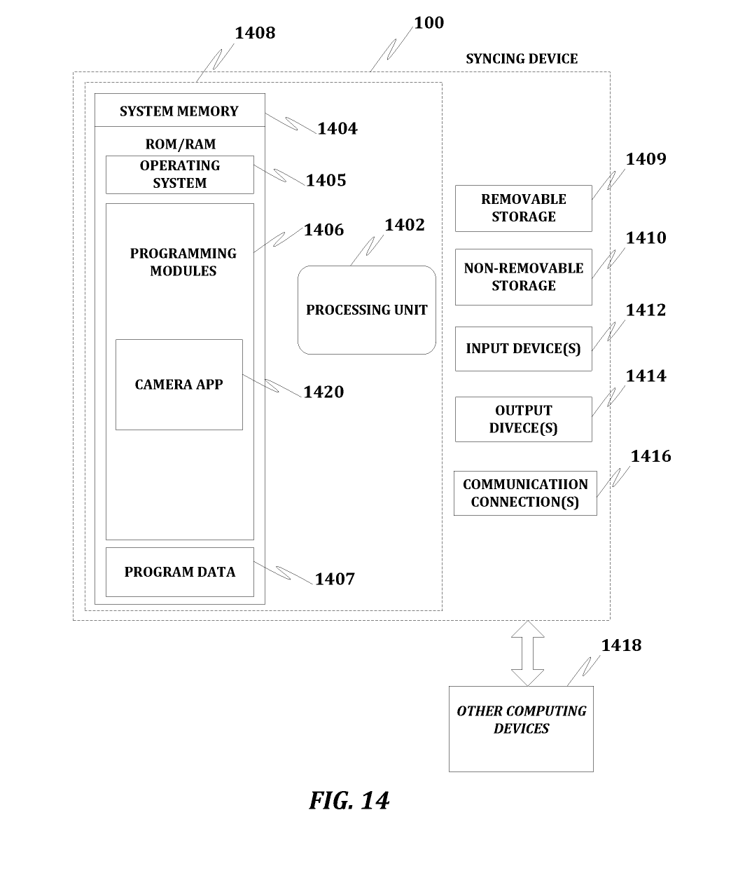

FIG. 14 is a block diagram of a system including the syncing device 102. Consistent with various embodiments of the disclosure, the aforementioned memory storage and processing unit may be implemented in a computing device, such as syncing device 102 of FIG. 1. Any suitable combination of hardware, software, or firmware may be used to implement the memory storage and processing unit. For example, the memory storage and processing unit may be implemented with syncing device 102 or any of other computing devices 1418, in combination with syncing device 102. The aforementioned system, device, and processors are examples and other systems, devices, and processors may comprise the aforementioned memory storage and processing unit, consistent with embodiments of the disclosure.

With reference to FIG. 14, a system consistent with various embodiments of the disclosure may include a syncing device, such as syncing device 102. In a basic configuration the syncing device 102 may include at least one processing unit 1402 and a system memory 1404. Depending on the configuration and type of computing device, system memory 1404 may comprise, but is not limited to, volatile (e.g. random access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling syncing device 102's operation. In one embodiment, programming modules 1406 may include a camera app 1420. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Syncing device 102 may have additional features or functionality. For example, syncing device 102 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and nonvolatile, removable and non-removable media implemented in any method or technology for storage of information, such as computer readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by syncing device 102. Any such computer storage media may be part of device 100. Syncing device 102 may also have input device(s) 1412 such as a keyboard, a mouse, a pen, a sound input device, a touch input device, etc. Output device(s) 1414 such as a display, speakers, a printer, etc. may also be included. The aforementioned devices are examples and others may be used.

Syncing device 102 may also contain a communication connection 1416 that may allow device 100 to communicate with other cometamputing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., the cameraapp1420) may perform processes including, for example, one or more stages of methods of FIG. 10-12 as described above. The aforementioned process is an example, and processing unit 1402 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### IV. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method for facilitating synchronization of a plurality of video content streams captured from multiple angles, the method comprising:
generating at least one code image using at least one syncing device, displaying the at least one code image on a display of the syncing device;
causing a first captured video content stream in the plurality of video content streams to include an image of the syncing device displaying a first code image of the at least one code image;
causing a second captured video content stream in the plurality of video content streams to include an image of the syncing device displaying a second code image of the at least one code image; and
synchronizing the first and second captured video content streams based at least in part on the first and the second code images.

2. The method of claim 1, wherein the at least one syncing device comprises a plurality of syncing devices, wherein the plurality of syncing devices is synchronized prior to including an image of the at least one code image on the plurality of video content streams.

3. The method of claim 2, wherein the at least one code image displayed by the plurality of syncing devices is captured in the plurality of video content streams at different times.

4. The method of claim 1, wherein a syncing device of the at least one syncing device displays a code image to be captured in each of the plurality of video content streams.

5. The method of claim 4, wherein the displaying comprises repeatedly flashing a code image of the at least one code image, wherein the code image is captured in each of the plurality of video content streams at the same time.

6. The method of claim 1, wherein the at least one syncing device is placed in front of a camera capturing a video content stream of the plurality of video content streams.

7. The method of claim 1, wherein the code image comprises at least one of a series of flashes and a coded visual.

8. The method of claim 1, wherein the code image includes identification of at least one of a camera and a scene.

9. The method of claim 1, further comprising generating metadata comprising timing information.

10. The method of claim 9, wherein the synchronizing comprises determining appearance of a code image in the plurality of video content streams based on the metadata.

11. The method of claim 1 further comprising controlling the at least one syncing device by a user.

12. The method of claim 1, wherein the at least one code image is captured on the plurality of video content streams at different time instants.

13. An apparatus for facilitating synchronization of a plurality of video content streams captured from multiple angles, the apparatus comprising:
at least one computer processor;
a display coupled to the at least one computer processor;
a code display module configured to operate the at least one computer processor to display at least one code image on the display, wherein the at least one code image is visually captured on the plurality of video content streams; and
a metadata generation module configured to generate metadata comprising time information, wherein the plurality of video content streams are synchronized based on each of the at least one code image and the metadata.

14. The apparatus of claim 13, wherein the code image comprises identification of at least one of a camera and a scene.

15. The apparatus of claim 13, wherein the code image comprises at least one of a series of flashes and a coded visual.

16. The apparatus of claim 13 further comprising a communication module configured to communicate the metadata to at least one external device, wherein the at least one external device is configured to perform synchronization of the plurality of video content streams.

17. The apparatus of claim 13, wherein a user controls the apparatus for facilitating synchronization of the plurality of video content streams.

18. A capturing device configured to capture a video content stream, the capturing device comprising:
a communication module configured to communicate data between the capturing device and a syncing device, wherein the communication comprises wireless reception of a control-input;
a means to capture content in response to the control-input, wherein the means to capture content is activated in response to the received control-input, wherein the syncing device is configured to display a one code image.

19. The capturing device of claim 18, wherein the means to capture content is configured to capture the code image displayed on the syncing device, wherein the code image includes identification of at least one of the capturing device and a scene, wherein the code image comprises at least one of a series of flashes and a coded visual.

20. The capturing device of claim 19, wherein synchronization of a plurality of video content streams comprising the video content stream captured by the capturing device is performable based on the code image.
